(19) United States
(12) Patent Application Publication
(10) Pub. No.: US 2026/0368961 A1
(43) Pub. Date: Nov. 19, 2026

(54) Per-Tile Selective Processing for Video Bokeh Power Reduction

(71) Applicant: Google LLC, Mountain View, CA (US)

(72) Inventors: Hee jun Park, San Diego, CA (US); Dmitri Bitouk, Orinda, CA (US); Yanru Li, San Diego, CA (US)

(21) Appl. No.: 19/139,523

(22) PCT Filed: Dec. 16, 2022
(86) PCT No.: PCT/US2022/081787

§ 371 Date: Jun. 16, 2025

(51) Int. Cl. G06T 11/60

(52) U.S. Cl. CPC G06T 11/60

(57) ABSTRACT

A method includes determining, from a plurality of image processing operations and for generation of captured video data with out-of-focus blurring, a first set of critical image processing operations and a second set of non-critical image processing operations. The method further includes determining, for an image frame of the captured video data, a first set of in-focus image tiles and a second set of out-of-focus image tiles. The method also includes applying each of the plurality of image processing operations to the first set of tiles. The method additionally includes applying the first set of critical image processing operations to the second set of tiles and omitting the second set of non-critical image processing operations for the second set of tiles. The method further includes generating a complete processed image frame by combining the first set of in-focus image tiles and the second set of out-of-focus image titles.

### BACKGROUND

Many modern computing devices, including mobile phones, personal computers, and tablets, are image capturing devices. Such devices may improve the aesthetic quality of displayed images or video by blurring out-of-focus regions (also referred to herein as the Bokeh effect). However, the processing required to produce this effect may be overly taxing for a computing device. Solutions to this problem include adjustments to effectuate a tradeoff between power utilization of the device and image quality (e.g., reducing the resolution of a captured and displayed image to save power). However, such solutions may not adequately take into consideration image contents and user experience.

### SUMMARY

Example systems and methods described herein may improve the performance of a video capturing device which is performing out-of-focus blurring (video Bokeh). Image frames may be divided into in-focus image tiles and out-of-focus image tiles. Additionally, processing operations to perform on the image frames may be divided into non-critical image processing operations and critical image processing operations. While the critical processing operations may be applied to all of the image tiles, the non-critical image processing operations may only be performed for the out-of-focus image tiles. Such arrangements may allow for improved device performance and provide additional opportunities for parallel processing to further improve performance.

In an embodiment, a method includes determining, from a plurality of image processing operations and for generation of captured video data with out-of-focus blurring, a first set of one or more critical image processing operations and a second set of one or more non-critical image processing operations. The method further includes determining, for an image frame of the captured video data, a first set of one or more in-focus image tiles of the image frame and a second set of one or more out-of-focus image tiles of the image frame. The method also includes applying each of the plurality of image processing operations to the first set of one or more in-focus image tiles. The method additionally includes applying the first set of one or more critical image processing operations to the second set of one or more out-of-focus image tiles and omitting the second set of one or more non-critical image processing operations for the second set of one or more out-of-focus image tiles. The method further includes generating a complete processed image frame by combining the first set of one or more in-focus image tiles and the second set of one or more out-of-focus image titles.

In another embodiment, a video capturing device is disclosed comprising one or more processors and one or more non-transitory computer readable media storing program instructions. The program instructions are executable by the one or more processors to perform operations. The operations include determining, from a plurality of image processing operations and for generation of captured video data with out-of-focus blurring, a first set of one or more critical image processing operations and a second set of one or more non-critical image processing operations. The operations further include determining, for an image frame of the captured video data, a first set of one or more in-focus image tiles of the image frame and a second set of one or more out-of-focus image tiles of the image frame. The operations additionally include applying each of the plurality of image processing operations to the first set of one or more in-focus image tiles. The operations also include applying the first set of one or more critical image processing operations to the second set of one or more out-of-focus image tiles and omitting the second set of one or more non-critical image processing operations for the second set of one or more out-of-focus image tiles. The operations further include generating a complete processed image frame by combining the first set of one or more in-focus image tiles and the second set of one or more out-of-focus image titles.

In a further embodiment, one or more non-transitory computer readable media storing program instructions are executable by one or more processors to perform operations. The operations include determining, from a plurality of image processing operations and for generation of captured video data with out-of-focus blurring, a first set of one or more critical image processing operations and a second set of one or more non-critical image processing operations. The operations further include determining, for an image frame of the captured video data, a first set of one or more in-focus image tiles of the image frame and a second set of one or more out-of-focus image tiles of the image frame. The operations also include applying each of the plurality of image processing operations to the first set of one or more in-focus image tiles. The operations additionally include applying the first set of one or more critical image processing operations to the second set of one or more out-of-focus image tiles and omitting the second set of one or more non-critical image processing operations for the second set of one or more out-of-focus image tiles. The operations also include generating a complete processed image frame by combining the first set of one or more in-focus image tiles and the second set of one or more out-of-focus image titles.

In a further embodiment, a system is provided that includes means for determining, from a plurality of image processing operations and for generation of captured video data with out-of-focus blurring, a first set of one or more critical image processing operations and a second set of one or more non-critical image processing operations. The system further includes means for determining, for an image frame of the captured video data, a first set of one or more in-focus image tiles of the image frame and a second set of one or more out-of-focus image tiles of the image frame. The system also includes means for applying each of the plurality of image processing operations to the first set of one or more in-focus image tiles. The system additionally includes means for applying the first set of one or more critical image processing operations to the second set of one or more out-of-focus image tiles and omitting the second set of one or more non-critical image processing operations for the second set of one or more out-of-focus image tiles. The system also includes means for generating a complete processed image frame by combining the first set of one or more in-focus image tiles and the second set of one or more out-of-focus image titles.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE DRAWINGS

FIG. 1 illustrates an example video capturing device, in accordance with example embodiments.

FIG. 2 is a simplified block diagram showing some of the components of an example video capturing device, in accordance with example embodiments.

FIG. 3 is a diagram illustrating selective application of image processing operations, in accordance with example embodiments.

FIG. 4 is a block diagram illustrating a video Bokeh processing pipeline with stereo depth, in accordance with example embodiments.

FIG. 5 is a block diagram illustrating a video Bokeh processing pipeline with stereo depth and selective application of image processing operations, in accordance with example embodiments.

FIG. 6 is a block diagram illustrating a video Bokeh processing pipeline with time-of-flight depth, in accordance with example embodiments.

FIG. 7 is a block diagram illustrating a video Bokeh processing pipeline with time-of-flight depth and selective application of image processing operations, in accordance with example embodiments.

FIG. 8 illustrates a timeline of performance of image processing operations for video Bokeh, in accordance with example embodiments.

FIG. 9 illustrates a timeline of performance of image processing operations with parallel processing for video Bokeh, in accordance with example embodiments.

FIG. 10 is a diagram illustrating per-tile depth estimation and per-tile motion vector estimation, in accordance with example embodiments.

FIG. 11 illustrates a bitmap indicating in-focus and out-of-focus image tiles, in accordance with example embodiments.

FIG. 12 is a flowchart of a method, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless indicated as such. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For the purpose of this description, the terms “multiple” and “a plurality of” refer to “two or more” or “more than one.”Further, unless context suggests otherwise, the features illustrated in each of the figures may be used in combination with one another. Thus, the figures should be generally viewed as component aspects of one or more overall embodiments, with the understanding that not all illustrated features are necessary for each embodiment. In the figures, similar symbols typically identify similar components, unless context dictates otherwise. Further, unless otherwise noted, figures are not drawn to scale and are used for illustrative purposes only. Moreover, the figures are representational only and not all components are shown. For example, additional structural or restraining components might not be shown.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Overview

A video capturing device, such as a digital camera, smartphone, or laptop computer, may include one or more image sensors (e.g., cameras) configured to capture video data containing image frames which represent the surrounding environment of the video capturing device. Through the Bokeh effect, the aesthetic quality of displayed video data may be improved by blurring out-of-focus regions. For instance, foreground objects may be displayed in focus while background areas are blurred in order to isolate and highlight the foreground objects from the surrounding background. In some cases, the computational load of video Bokeh processing may be excessive, causing video latency, device overheating, and/or other operational limitations. Solutions which limit the quality of the entire displayed video, such as lowering the resolution, frames per second (FPS), or turning off entire features may cause an undesirable depreciation of image quality.

Examples described herein provide improved processing efficiency for a video capture device running the video Bokeh use case. More specifically, image processing operations may be divided into two groups: critical image processing operations and non-critical processing operations. As described herein, critical processing operations may comprise processing operations which have a large impact on the final image quality of both in-focus regions and out-of-focus regions. Meanwhile, non-critical image processing operations may comprise processing operations which have a minimal impact on out-of-focus regions in the final resulting image quality. An example of a critical image processing operation may be depth estimation. Examples of non-critical image processing operations may include temporal noise reduction, high dynamic range (HDR) image enhancement, and/or machine learning processing for object detection. In some examples, the set of critical operations and the set of non-critical operations may be adjusted dynamically based on the current operating state of the video capturing device, such as a measure of latency or a power or thermal condition of the video capturing device.

For each image frame of captured video data, image tiles (e.g., grids or blocks or regions of the image frame) may be classified into one of two groups: in-focus image tiles (e.g., foreground tiles) and out-of-focus image tiles (e.g., background tiles). All of the image processing operations (including both the operations classified as critical and the operations classified as non-critical) may be applied for the in-focus image tiles. Meanwhile, only the critical image processing operations may be applied to the out-of-focus image tiles, while the non-critical image processing operations are omitted to reduce latency, power utilization, and/or thermal impact on the video capturing device. In order to efficiently determine which image processing operations to apply to each tile of an image frame, a bitmap may be determined and stored as metadata which indicates which image tiles to skip when performing image processing operations classified as non-critical.

In further examples, by utilizing per-tile image processing, additional computational benefits may be obtained through parallel processing. More specifically, in some examples, per-tile motion vector estimation may be processed after per-tile depth estimation in a pipelined way to minimize the latency, in contrast to systems which process entire image frames at once. In additional examples, after determining which image processing operations to perform on a per tile basis, one or more non-critical image processing operations may be applied to in-focus image tiles in parallel with applying a blurring effect to out-of-focus image tiles.

In additional examples, further computational benefits may be obtained by mapping out-of-focus image tiles and in-focus image tiles to three different data streams. In particular, a first data stream identifier may correspond to all image tiles, a second data stream identifier may correspond to out-of-focus image tiles, and a third data stream identifier may correspond to in-focus image tiles. The data stream identifiers may then be used to efficiently apply image processing operations classified as critical or non-critical. In such examples, image tiles associated with the second data stream identifier and image tiles associated with the third data stream identifier may be processed in parallel. In further examples, a translation lookaside buffer (TLB) may be used for the first data stream identifier, the second data stream identifier, and the third data stream identifier.

### II. Example Systems and Methods

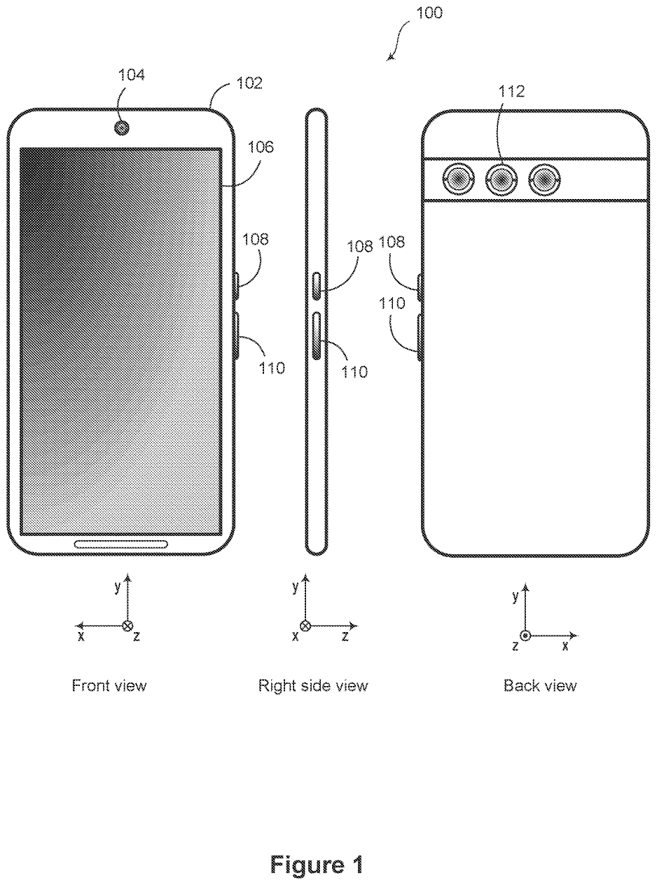

FIG. 1 illustrates an example computing device 100. In examples described herein, computing device 100 may be a video capturing device. Computing device 100 is shown in the form factor of a mobile phone. However, computing device 100 may be alternatively implemented as a laptop computer, a tablet computer, and/or a wearable computing device, among other possibilities. Computing device 100 may include various elements, such as body 102, display 106, and buttons 108 and 110. Computing device 100 may further include one or more cameras, such as front-facing camera 104 and at least one rear-facing camera 112. In examples with multiple rear-facing cameras such as illustrated in FIG. 1, each of the rear-facing cameras may have a different field of view. For example, the rear facing cameras may include a wide angle camera, a main camera, and a telephoto camera. The wide angle camera may capture a larger portion of the environment compared to the main camera and the telephoto camera, and the telephoto camera may capture more detailed images of a smaller portion of the environment compared to the main camera and the wide angle camera.

Front-facing camera 104 may be positioned on a side of body 102 typically facing a user while in operation (e.g., on the same side as display 106). Rear-facing camera 112 may be positioned on a side of body 102 opposite front-facing camera 104. Referring to the cameras as front and rear facing is arbitrary, and computing device 100 may include multiple cameras positioned on various sides of body 102.

Display 106 could represent a cathode ray tube (CRT) display, a light emitting diode (LED) display, a liquid crystal (LCD) display, a plasma display, an organic light emitting diode (OLED) display, or any other type of display known in the art. In some examples, display 106 may display a digital representation of the current image being captured by front-facing camera 104 and/or rear-facing camera 112, an image that could be captured by one or more of these cameras, an image that was recently captured by one or more of these cameras, and/or a modified version of one or more of these images. Thus, display 106 may serve as a viewfinder for the cameras. Display 106 may also support touchscreen functions that may be able to adjust the settings and/or configuration of one or more aspects of computing device 100.

Front-facing camera 104 may include an image sensor and associated optical elements such as lenses. Front-facing camera 104 may offer zoom capabilities or could have a fixed focal length. In other examples, interchangeable lenses could be used with front-facing camera 104. Front-facing camera 104 may have a variable mechanical aperture and a mechanical and/or electronic shutter. Front-facing camera 104 also could be configured to capture still images, video images, or both. Further, front-facing camera 104 could represent, for example, a monoscopic, stereoscopic, or multiscopic camera. Rear-facing camera 112 may be similarly or differently arranged. Additionally, one or more of front-facing camera 104 and/or rear-facing camera 112 may be an array of one or more cameras.

One or more of front-facing camera 104 and/or rear-facing camera 112 may include or be associated with an illumination component that provides a light field to illuminate a target object. For instance, an illumination component could provide flash or constant illumination of the target object. An illumination component could also be configured to provide a light field that includes one or more of structured light, polarized light, and light with specific spectral content. Other types of light fields known and used to recover three-dimensional (3D) models from an object are possible within the context of the examples herein.

Computing device 100 may also include an ambient light sensor that may continuously or from time to time determine the ambient brightness of a scene that cameras 104 and/or 112 can capture. In some implementations, the ambient light sensor can be used to adjust the display brightness of display 106. Additionally, the ambient light sensor may be used to determine an exposure length of one or more of cameras 104 or 112, or to help in this determination.

Computing device 100 could be configured to use display 106 and front-facing camera 104 and/or rear-facing camera 112 to capture images of a target object. The captured images could be a plurality of still images or a video stream. The image capture could be triggered by activating button 108, pressing a softkey on display 106, or by some other mechanism. Depending upon the implementation, the images could be captured automatically at a specific time interval, for example, upon pressing button 108, upon appropriate lighting conditions of the target object, upon moving computing device 100 a predetermined distance, or according to a predetermined capture schedule.

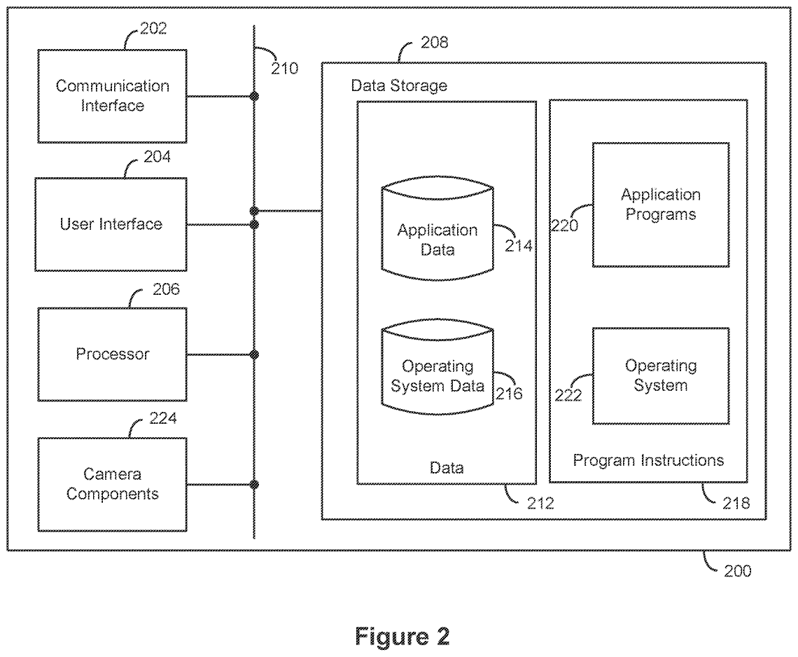

FIG. 2 is a simplified block diagram showing some of the components of an example computing system 200, such as a video capturing device. By way of example and without limitation, computing system 200 may be a cellular mobile telephone (e.g., a smartphone), a computer (such as a desktop, notebook, tablet, server, or handheld computer), a home automation component, a digital video recorder (DVR), a digital television, a remote control, a wearable computing device, a gaming console, a robotic device, a vehicle, or some other type of device. Computing system 200 may represent, for example, aspects of computing device 100.

As shown in FIG. 2, computing system 200 may include communication interface 202, user interface 204, processor 206, data storage 208, and camera components 224, all of which may be communicatively linked together by a system bus, network, or other connection mechanism 210. Computing system 200 may be equipped with at least some image capture and/or image processing capabilities. It should be understood that computing system 200 may represent a physical image processing system, a particular physical hardware platform on which an image sensing and/or processing application operates in software, or other combinations of hardware and software that are configured to carry out image capture and/or processing functions.

Communication interface 202 may allow computing system 200 to communicate, using analog or digital modulation, with other devices, access networks, and/or transport networks. Thus, communication interface 202 may facilitate circuit-switched and/or packet-switched communication, such as plain old telephone service (POTS) communication and/or Internet protocol (IP) or other packetized communication. For instance, communication interface 202 may include a chipset and antenna arranged for wireless communication with a radio access network or an access point. Also, communication interface 202 may take the form of or include a wireline interface, such as an Ethernet, Universal Serial Bus (USB), or High-Definition Multimedia Interface (HDMI) port, among other possibilities. Communication interface 202 may also take the form of or include a wireless interface, such as a Wi-Fi, BLUETOOTH®, global positioning system (GPS), or wide-area wireless interface (e.g., WiMAX or 3GPP Long-Term Evolution (LTE)), among other possibilities. However, other forms of physical layer interfaces and other types of standard or proprietary communication protocols may be used over communication interface 202. Furthermore, communication interface 202 may comprise multiple physical communication interfaces (e.g., a Wi-Fi interface, a BLUETOOTH® interface, and a wide-area wireless interface).

User interface 204 may function to allow computing system 200 to interact with a human or non-human user, such as to receive input from a user and to provide output to the user. Thus, user interface 204 may include input components such as a keypad, keyboard, touch-sensitive panel, computer mouse, trackball, joystick, microphone, and so on. User interface 204 may also include one or more output components such as a display screen, which, for example, may be combined with a touch-sensitive panel. The display screen may be based on CRT, LCD, LED, and/or OLED technologies, or other technologies now known or later developed. User interface 204 may also be configured to generate audible output(s), via a speaker, speaker jack, audio output port, audio output device, earphones, and/or other similar devices. User interface 204 may also be configured to receive and/or capture audible utterance(s), noise(s), and/or signal(s) by way of a microphone and/or other similar devices.

In some examples, user interface 204 may include a display that serves as a viewfinder for still camera and/or video camera functions supported by computing system 200. Additionally, user interface 204 may include one or more buttons, switches, knobs, and/or dials that facilitate the configuration and focusing of a camera function and the capturing of images. It may be possible that some or all of these buttons, switches, knobs, and/or dials are implemented by way of a touch-sensitive panel.

Processor 206 may comprise one or more general purpose processors—e.g., microprocessors—and/or one or more special purpose processors—e.g., digital signal processors (DSPs), graphics processing units (GPUs), floating point units (FPUs), network processors, or application-specific integrated circuits (ASICs). In some instances, special purpose processors may be capable of image processing, image alignment, and merging images, among other possibilities. Data storage 208 may include one or more volatile and/or non-volatile storage components, such as magnetic, optical, flash, or organic storage, and may be integrated in whole or in part with processor 206. Data storage 208 may include removable and/or non-removable components.

Processor 206 may be capable of executing program instructions 218 (e.g., compiled or non-compiled program logic and/or machine code) stored in data storage 208 to carry out the various functions described herein. Therefore, data storage 208 may include a non-transitory computer-readable medium, having stored thereon program instructions that, upon execution by computing system 200, cause computing system 200 to carry out any of the methods, processes, or operations disclosed in this specification and/or the accompanying drawings. The execution of program instructions 218 by processor 206 may result in processor 206 using data 212.

By way of example, program instructions 218 may include an operating system 222 (e.g., an operating system kernel, device driver(s), and/or other modules) and one or more application programs 220 (e.g., camera functions, address book, email, web browsing, social networking, audio-to-text functions, text translation functions, and/or gaming applications) installed on computing system 200. Similarly, data 212 may include operating system data 216 and application data 214. Operating system data 216 may be accessible primarily to operating system 222, and application data 214 may be accessible primarily to one or more of application programs 220. Application data 214 may be arranged in a file system that is visible to or hidden from a user of computing system 200.

Application programs 220 may communicate with operating system 222 through one or more application programming interfaces (APIs). These APIs may facilitate, for instance, application programs 220 reading and/or writing application data 214, transmitting or receiving information via communication interface 202, receiving and/or displaying information on user interface 204, and so on.

In some cases, application programs 220 may be referred to as “apps” for short. Additionally, application programs 220 may be downloadable to computing system 200 through one or more online application stores or application markets. However, application programs can also be installed on computing system 200 in other ways, such as via a web browser or through a physical interface (e.g., a USB port) on computing system 200.

Camera components 224 may include, but are not limited to, an aperture, shutter, recording surface (e.g., photographic film and/or an image sensor), lens, shutter button, infrared projectors, and/or visible-light projectors. Camera components 224 may include components configured for capturing of images in the visible-light spectrum (e.g., electromagnetic radiation having a wavelength of 380-700 nanometers) and/or components configured for capturing of images in the infrared light spectrum (e.g., electromagnetic radiation having a wavelength of 701 nanometers-1 millimeter), among other possibilities. Camera components 224 may be controlled at least in part by software executed by processor 206.

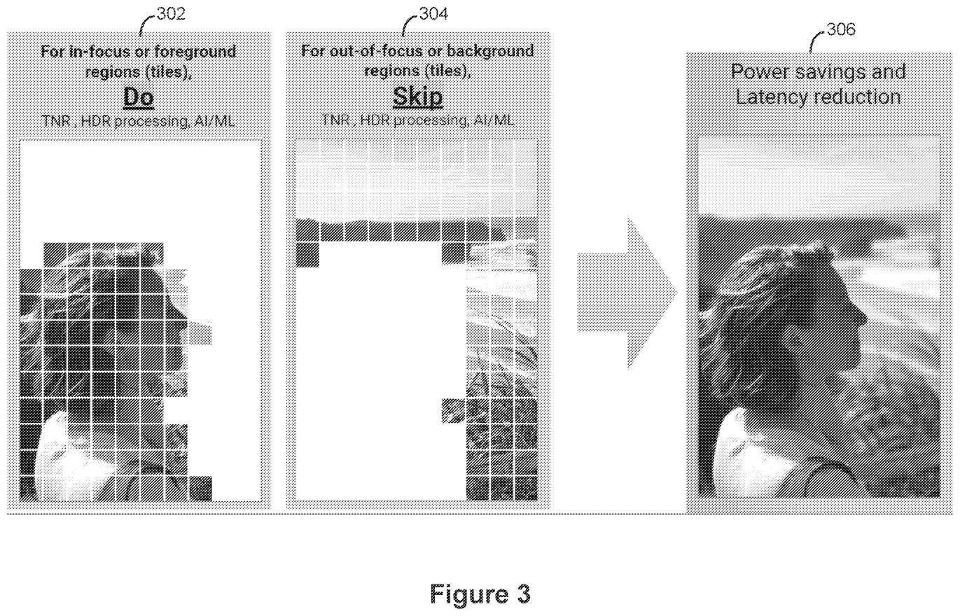

FIG. 3 is a diagram illustrating selective application of image processing operations, in accordance with example embodiments. More specifically, a captured image frame may be divided into in-focus image tiles 302 and out-of-focus image tiles 304. The determination of whether each tile of the image is considered in-focus or out-of-focus may be based on depth measurements in order bring foreground objects into the in-focus region. In some examples, the total number of tiles for a captured image frame may be set to a predetermined number (e.g., 10×14=140 tiles, as illustrated in FIG. 3). In further examples, the number of tiles to divide the image frame into may be determined based on contents of the image frame. For example, a greater number of smaller tiles may be used to more precisely separate foreground objects from background if needed.

For in-focus image tiles 302, certain image processing operations classified as non-critical may be applied. For instance, as illustrated in FIG. 3, temporal noise reduction (TNR), high dynamic range (HDR) processing, and artificial intelligence (AI)/machine learning (ML) processing may be applied to each of in-focus image tiles 302. By contrast, for out-of-focus image tiles 304, the image processing operations classified as non-critical may be skipped. For instance, TNR, HDR processing, and AI/ML processing may all be omitted for out-of-focus image tiles 304. It may be determined to be unnecessary to perform such operations on the out-of-focus image tiles 304 given that the background regions will be blurred in the complete processed image frame 306 (resulting from combining each of in-focus image tiles 302 and each of out-of-focus image tiles 304) for video Bokeh. For instance, blurring may naturally reduce temporal noise, minimizing the impact of TNR processing. Additionally, HDR image enhancement may be mostly lost in the blurring process. Furthermore, AI/ML processing (e.g., for object detection) may not be intended in regions to be blurred. Accordingly, in generating processed image frame 306, power savings and/or latency reduction may be obtained for a video capturing device through the use of selective per-tile image processing.

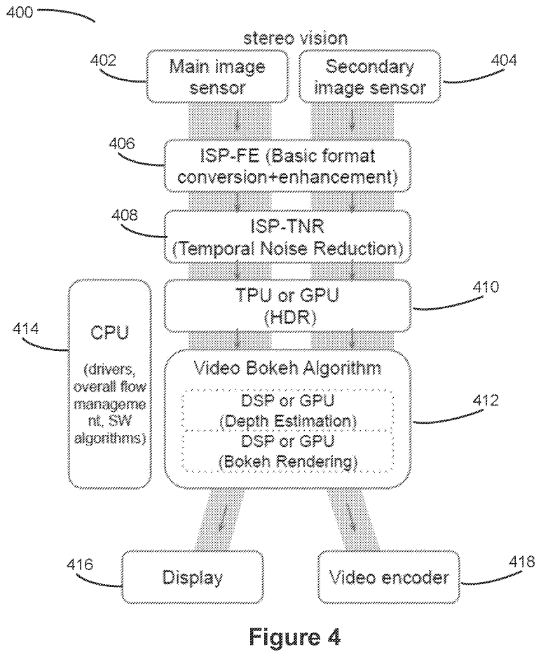

FIG. 4 is a block diagram illustrating a video Bokeh processing pipeline with stereo depth, in accordance with example embodiments. More specifically, pipeline 400 may start with a main image sensor 402 and a secondary image sensor 404 of a video capturing device. The main image sensor 402 and the secondary image sensor 404 may capture video data or images representing the environment of the video capturing device from two different perspectives for stereo processing. In the illustrated example pipeline 400, the images from main image sensor 402 and secondary image sensor 404 may be input into image signal processing front end (ISP-FE) hardware 406 of the video capturing device for basic format conversion and enhancement. The images may then be processed by image signal processing temporal noise reduction (TNR) hardware 408 to perform TNR operations. The images may then be processed by a tensor processing unit (TPU) or graphics processing unit (GPU) for HDR enhancement 410. Subsequently, the images may be processed by a video Bokeh algorithm 412, which may include digital signal processor (DSP) or GPU depth estimation and Bokeh rendering.

As illustrated in FIG. 4, a central processing unit (CPU) 414 may include drivers and software algorithms for overall flow management to facilitate pipeline 400. After application of video Bokeh algorithm 412, the resulting image data may be provided to display 416 (e.g., a screen of the video capturing device) for display on the video capturing device. The resulting image data may also be provided to a video encoder 418 that encodes raw image data into a video stream (e.g., for saving or for export from the device).

Notably in pipeline 400, all of the illustrated image processing operations are applied to entire captured image frames as part of the video Bokeh process. Therefore, pipeline 400 may lead to inefficient processing and complications with respect to device latency, overheating, and/or limiting other processes of the video capturing device.

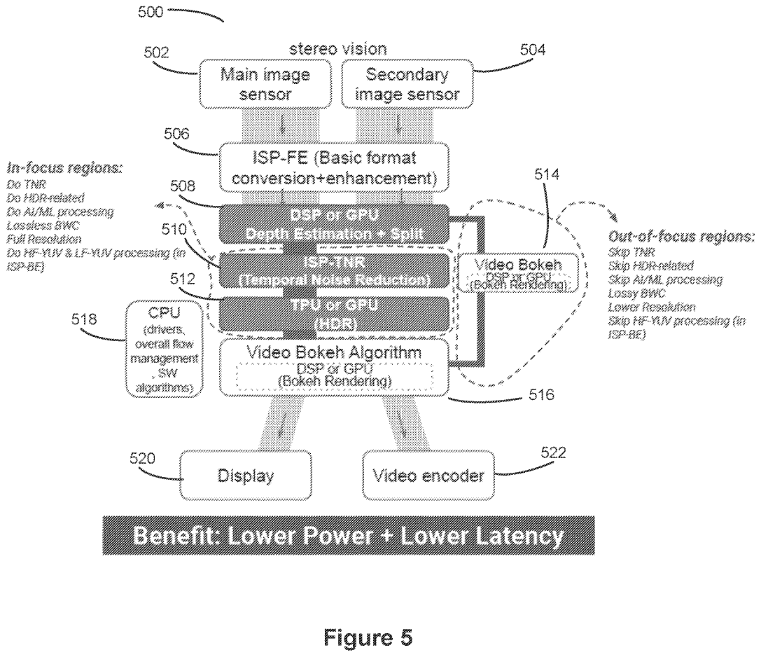

FIG. 5 is a block diagram illustrating a video Bokeh processing pipeline with stereo depth and selective application of image processing operations, in accordance with example embodiments. More specifically, pipeline 500 may start with a main image sensor 502 and a secondary image sensor 504 of a video capturing device. The main image sensor 502 and the secondary image sensor 504 may capture video data or images representing the environment of the video capturing device from two different perspectives for stereo processing. In the illustrated example pipeline 500, the images from main image sensor 502 and secondary image sensor 504 may be input into ISP-FE hardware 506 of the video capturing device for basic format conversion and enhancement. Because these conversion and enhancement operations are applied to all image tiles of each image frame, they may be considered to be critical operations for the video Bokeh process. In contrast to FIG. 4, the images may then be processed by a DSP or GSP for depth estimation 508 as part of the video Bokeh process. Because the depth estimation operations are applied to all image tiles of each image process, they may also be considered to be critical operations for the video Bokeh process.

Subsequently, only in-focus image tiles may be processed by ISP TNR hardware 510 to perform TNR operations. The image data for these in-focus image tiles may then be processed by a TPU or GPU for HDR enhancement 512. Subsequently, the image data for these in-focus image tiles may be processed by a video Bokeh algorithm 516, which may include digital signal processor (DSP) or GPU Bokeh rendering (in this case, the depth estimation was already performed at block 508).

By contrast, out-of-focus image tiles may not be processed by ISP TNR hardware 510 to perform TNR operations and the TPU or GPU for HDR enhancement 512. Accordingly, these image processing operations may be considered to be non-critical operations which are omitted for out-of-focus regions. Instead, the out-of-focus image tiles may be processed only for Video Bokeh 514 by a DSP or GPU, for instance, to blur the background regions. Notably, such blurring of out of focus regions may be performed in parallel with the performance of other operations (such as TNR or HDR enhancement) on the in-focus regions.

A CPU may include drivers and software algorithms for overall flow management to facilitate pipeline 500. After application of video Bokeh rendering 514 and 516 on both the in-focus image tiles and the out-of-focus image tiles, the resulting image data may be provided to display 520 (e.g., a screen of the video capturing device) for display on the video capturing device. The resulting image data may also be provided to a video encoder 522 that encodes raw image data into a video stream (e.g., for saving or for export from the device).

As illustrated in FIG. 5, in some examples, image processing operations performed on in-focus regions may include TNR, HDR-related enhancements, AI/ML processing, lossless bandwidth compression (BWC), full resolution image processing, and high frequency (HF) and low frequency (LF) YUV color processing. By contrast, for out-of-focus regions, TNR, HDR-related enhancements, and AI/ML processing may be omitted. Additionally, processing of out-of-focus regions may include lossy BWC and lower resolution image processing, and HF YUV color processing may be omitted. Benefits for the video capturing device including lower power consumption and/or lower latency may be obtained through this selective processing of individual image tiles.

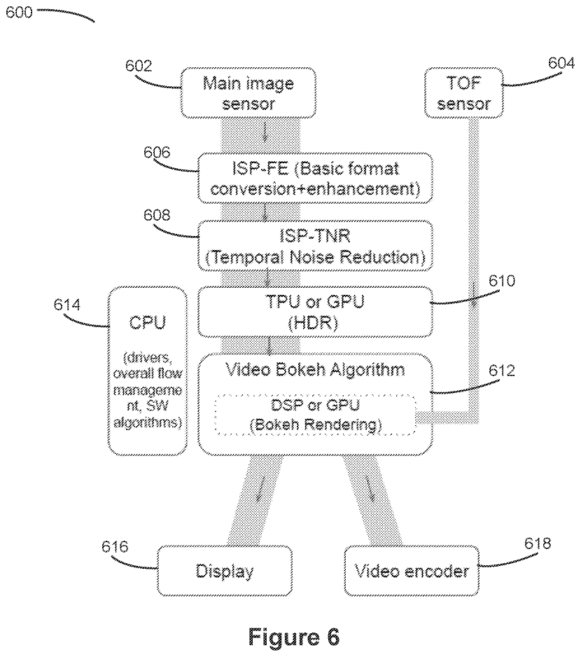

FIG. 6 is a block diagram illustrating a video Bokeh processing pipeline with time-of-flight depth, in accordance with example embodiments. In contrast to FIGS. 4 and 5, FIG. 6 illustrates pipeline 600 with depth determined using a time-of-flight (TOF) sensor rather than through stereo processing. Accordingly, pipeline 600 may start with a main image sensor 602 and a TOF sensor 604 of a video capturing device. The main image sensor 602 may capture video data or images representing the environment of the video capturing device. In the illustrated example pipeline 600, the images from main image sensor 602 may be input into ISP-FE hardware 606 of the video capturing device for basic format conversion and enhancement. The images may then be processed by ISP TNR hardware 608 to perform TNR operations. The images may then be processed by a TPU or GPU for HDR enhancement 610. Subsequently, the images may be processed by a video Bokeh algorithm 612, which may include digital signal processor (DSP) or GPU Bokeh rendering. Depth rendering for the video Bokeh algorithm 612 may be performed using the depth data from the TOF sensor 604.

As illustrated in FIG. 6, a central processing unit (CPU) 614 may include drivers and software algorithms for overall flow management to facilitate pipeline 600. After application of video Bokeh algorithm 612, the resulting image data may be provided to display 616 (e.g., a screen of the video capturing device) for display on the video capturing device. The resulting image data may also be provided to a video encoder 618 that encodes raw image data into a video stream (e.g., for saving or for export from the device).

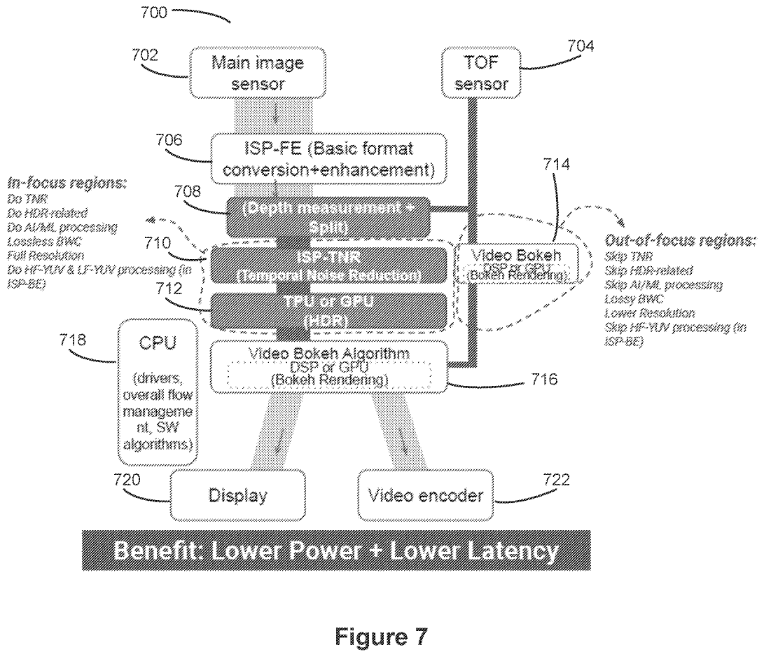

FIG. 7 is a block diagram illustrating a video Bokeh processing pipeline with time-of-flight depth and selective application of image processing operations, in accordance with example embodiments. As in FIG. 6, FIG. 7 illustrates pipeline 700 with depth determined using a time-of-flight (TOF) sensor rather than through stereo processing. Accordingly, pipeline 700 may start with a main image sensor 702 and a TOF sensor 704 of a video capturing device. The main image sensor 702 may capture video data or images representing the environment of the video capturing device. In the illustrated example pipeline 700, the images from main image sensor 702 may be input into ISP-FE hardware 706 of the video capturing device for basic format conversion and enhancement. Because these conversion and enhancement operations are applied to all image tiles of each image frame, they may be considered to be critical operations for the video Bokeh process. The images may then be processed to determine depth estimation 708 using sensor data from TOF sensor 704. Because the depth estimation operations are applied to all image tiles of each image process, they may also be considered to be critical operations for the video Bokeh process.

Subsequently, only in-focus image tiles may be processed by ISP TNR hardware 710 to perform TNR operations. The image data for these in-focus image tiles may then be processed by a TPU or GPU for HDR enhancement 712. Subsequently, the image data for these in-focus image tiles may be processed by a video Bokeh algorithm 716, which may include digital signal processor (DSP) or GPU Bokeh rendering.

By contrast, out-of-focus image tiles may not be processed by ISP TNR hardware 510 to perform TNR operations and the TPU or GPU for HDR enhancement 512. Accordingly, these image processing operations may be considered to be non-critical operations which are omitted for out-of-focus regions. Instead, the out-of-focus image tiles may be processed only for Video Bokeh 714 by a DSP or GPU, for instance, to blur the background regions. Notably, such blurring of out of focus regions may be performed in parallel with the performance of other operations (such as TNR or HDR enhancement) on the in-focus regions.

A CPU may include drivers and software algorithms for overall flow management to facilitate pipeline 700. After application of video Bokeh rendering 714 and 716 on both the in-focus image tiles and the out-of-focus image tiles, the resulting image data may be provided to display 720 (e.g., a screen of the video capturing device) for display on the video capturing device. The resulting image data may also be provided to a video encoder 722 that encodes raw image data into a video stream (e.g., for saving or for export from the device).

Similar to FIG. 5 in the context of stereo depth, FIG. 7 illustrates that image processing operations performed on in-focus regions may include TNR, HDR-related enhancements, AI/ML processing, lossless bandwidth compression (BWC), full resolution image processing, and high frequency (HF) and low frequency (LF) YUV color processing. By contrast, for out-of-focus regions, TNR, HDR-related enhancements, and AI/ML processing may be omitted. Additionally, processing of out-of-focus regions may include lossy BWC and lower resolution image processing, and HF YUV color processing may be omitted. Benefits for the video capturing device including lower power consumption and/or lower latency may therefore also be obtained through this selective processing of individual image tiles in the context of a device which uses a TOF sensor for depth estimation.

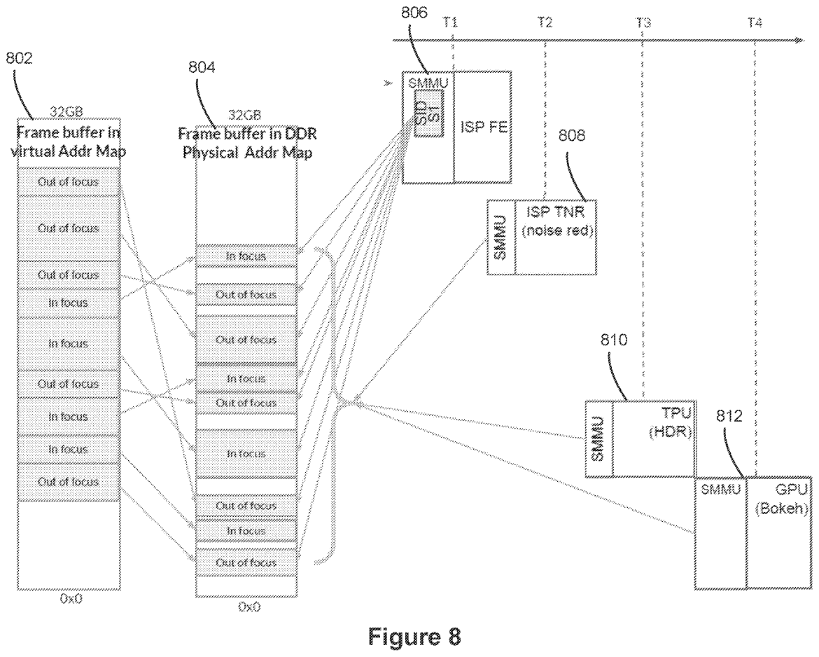

FIG. 8 illustrates a timeline of performance of image processing operations for video Bokeh, in accordance with example embodiments. More specifically, a stream identifier (SID) scheme for a system memory management unit (SMMU) is illustrated for a video Bokeh processing pipeline, such as pipeline 400 illustrated in FIG. 4. The timeline illustrated in FIG. 8 shows the performance of different image processing operations at different hardware and/or software components of a video capturing device.

As shown in FIG. 8, in-focus and out-of-focus regions of an image are mapped from virtual memory 802 to corresponding addresses in physical memory 804. All of the image regions (including both the in-focus regions and the out-of-focus regions) are mapped to a SID S1 to enable performance of image processing operations. Accordingly, at T1, basic format conversion and enhancement operations are performed by ISP FE hardware 806. Subsequently, at T2, TNR operations are performed by ISP TNR hardware 808. Then, at T3, HDR enhancement operations are performed by TPU 810. Finally, at T4, the video Bokeh algorithm (including depth estimation and Bokeh rendering) is performed by GPU 812.

As illustrated in FIG. 8, format conversion and enhancement, INR, HDR enhancement, and the video Bokeh algorithm may therefore be performed sequentially on entire image frames. However, processing benefits can be obtained when in-focus and out-of-focus image tiles are processed separately.

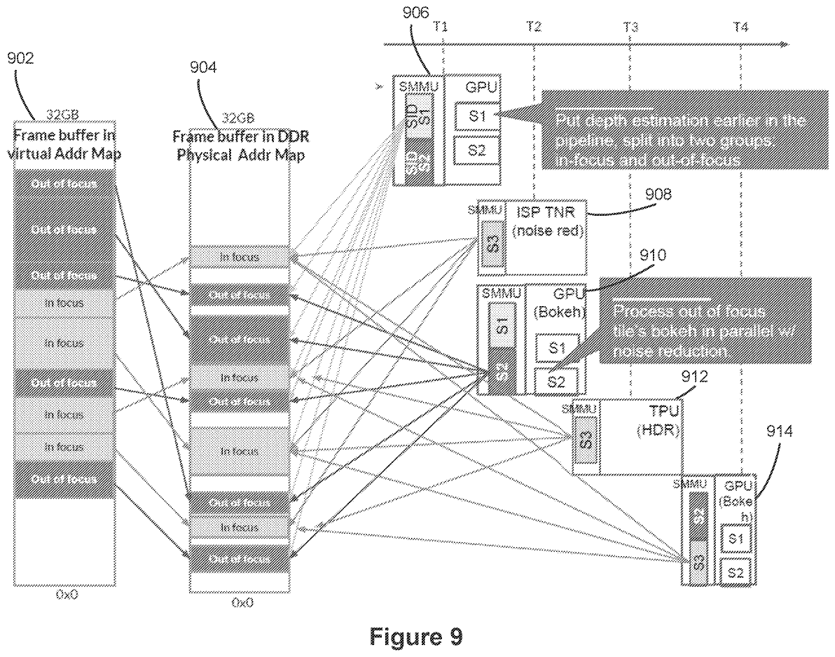

FIG. 9 illustrates a timeline of performance of image processing operations with parallel processing for video Bokeh, in accordance with example embodiments. More specifically, a SID scheme for an SMMU is illustrated for a video Bokeh processing pipeline which includes selective processing, such as pipeline 500 illustrated in FIG. 5. The timeline illustrated in FIG. 9 shows the performance of different image processing operations at different hardware and/or software components of a video capturing device, which in this case includes parallel processing.

As shown in FIG. 9, in-focus and out-of-focus regions of an image are mapped from virtual memory 902 to corresponding addresses in physical memory 904. The image regions are then mapped to three different SIDs to enable performance of image processing operations. In particular, all of the image regions (including out-of-focus image tiles and in-focus image tiles) are mapped to SID S1, the out-of-focus image tiles are mapped to SID S2, and the in-focus image tiles are mapped to SID S3. SID S1, S2, and S3 may be used to more efficiently apply critical and non-critical image processing operations. The three SIDs may share one table lookaside buffer (TLB), in order to avoid causing any memory footprint overhead.

Accordingly, at T1, depth estimation operations are first performed by GPU 906 on all image tiles associated with SID S1 in order to divide the image tiles into two groups. The first group of out-of-focus image tiles are mapped to SID S2 and the second group of in-focus image tiles are mapped to SID S3. Subsequently, at T2, TNR operations are performed by ISP TNR hardware 908 only on in-focus images tiles mapped to SID S3. In parallel with these TNR operations, video Bokeh algorithm operations are performed by GPU 910 on the out-of-focus image tiles. Then, at T3, HDR enhancement operations are performed by TPU 912 only on the in-focus image tiles mapped to SID S3. Finally, at T4, the video Bokeh algorithm is performed by GPU 914 on the in-focus image tiles mapped to SID S3.

As illustrated in FIG. 9, certain image processing operations (in the illustrated example, TNR and Bokeh blurring) may be performed in parallel on in-focus and out-of-focus image regions (leveraging SID S2 and SID S3) to improve the processing time for a video Bokeh algorithm. In further examples, other image processing operations classified as non-critical and critical may be performed in parallel on in-focus and out-of-focus image regions as well or instead.

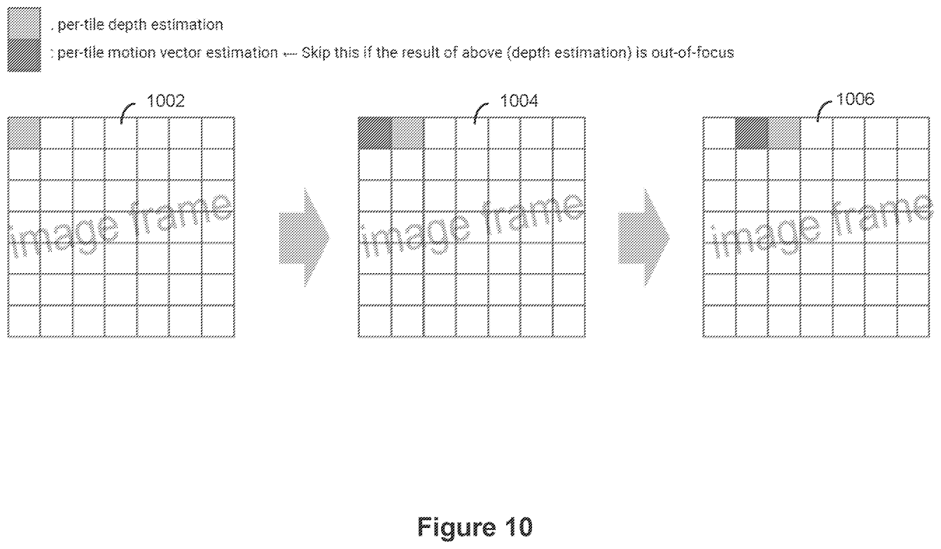

FIG. 10 is a diagram illustrating per-tile depth estimation and per-tile motion vector estimation, in accordance with example embodiments. More specifically, by performing depth estimation per-tile and also motion vector estimation per-tile (e.g., for HDR processing), processing time may be improved in comparison to systems that first perform depth estimation on an entire image frame followed by performing motion vector estimation on the entire image frame.

Image frame 1002 illustrates an initial performance of depth estimation on a first image tile of the image frame. Subsequently, image frame 1004 illustrates a subsequent performance of depth estimation on a second image tile of the image frame. This depth estimation on the second image tile may be performed in parallel with performing motion vector estimation on the first image tile. Furthermore, the motion vector estimation on the first image tile may only be performed if the result of the depth estimation for the first image tile indicates that the first image tile is in-focus. Subsequently, image frame 1006 illustrates a subsequent performance of depth estimation on a third image tile of the image frame. This depth estimation on the third image tile may be performed in parallel with performing motion vector estimation on the second image tile. Furthermore, the motion vector estimation on the second image tile may only be performed if the result of the depth estimation for the second image tile indicates that the second image tile is in-focus.

The pipelined per-tile processing illustrated in FIG. 10 therefore provides multiple potential processing improvements over per-frame processing. First, motion vector estimation (as a non-critical operation) may be avoided for out-of-focus tiles. Second, when motion vector estimation is needed (for in-focus tiles), these operations may be performed in parallel with depth estimation for subsequent image tiles of an image frame.

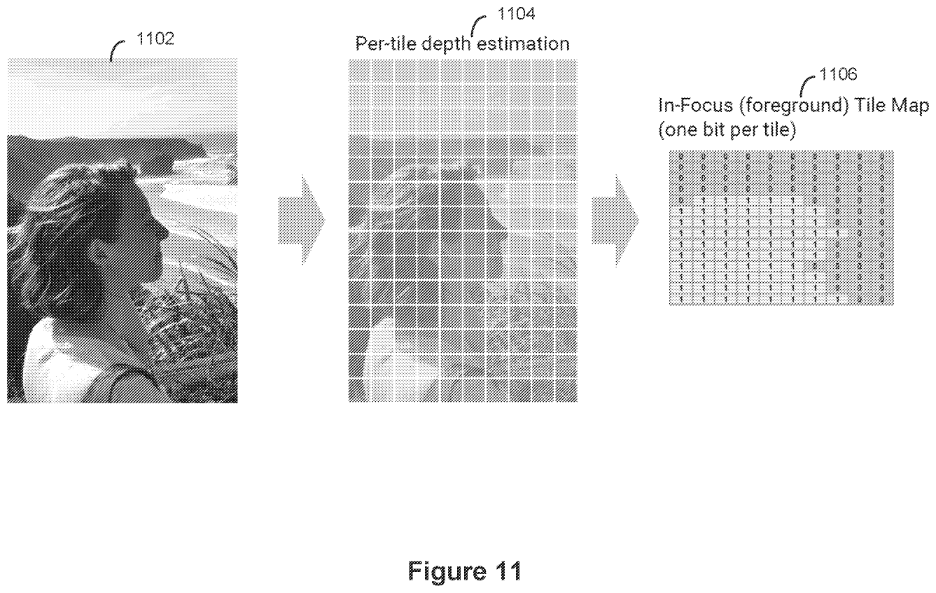

FIG. 11 illustrates a bitmap indicating in-focus and out-of-focus image tiles, in accordance with example embodiments. More specifically, a bitmap may be generated and stored which contains metadata for the in-focus (e.g., foreground) image tiles in order to indicate which tiles to skip when performing image processing operations designated as non-critical. For instance, FIG. 11 illustrates a captured image frame 1102. When per-tile depth estimation 1104 is performed on the captured image frame 1102, individual depth estimates may be obtained for each of the illustrated image tiles. A bitmap 1106 may then be generated which contains a “1” value for all in-focus (e.g., foreground) image tiles. The bitmap 1106 may contain a “0” for all out-of-focus (e.g., background) image tiles. The bitmap 1106 may be stored in memory of a video capturing device, and then referenced to determine whether to perform image processing operations designated as non-critical (e.g., TNR, HDR, and/or AI/ML processing) on each individual image tile or not.

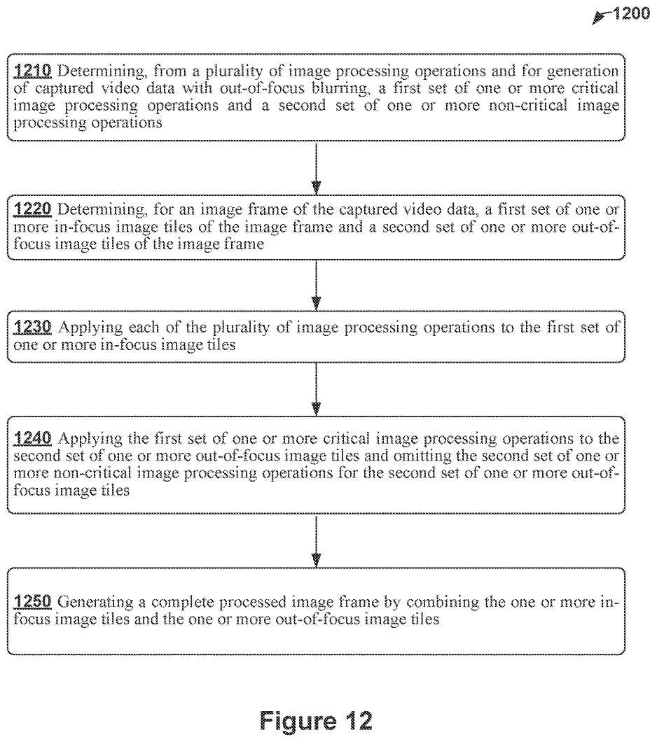

FIG. 12 is a flowchart of a method, in accordance with example embodiments. Method 1200 of FIG. 12 may be executed by one or more computing systems (e.g., computing system 200 of FIG. 2) and/or one or more processors (e.g., processor 206 of FIG. 2). Method 1200 may be carried out on a computing device, such as computing device 100 of FIG. 1. In some examples, each block of method 1200 may be performed locally on a video capturing device. In alternative examples, a portion or all of the blocks of method 1200 may be performed by one or more computing systems remote from a video capturing device.

At block 1210, method 1200 includes determining, from a plurality of image processing operations and for generation of captured video data with out-of-focus blurring, a first set of one or more critical image processing operations and a second set of one or more non-critical image processing operations.

At block 1220, method 1200 includes determining, for an image frame of the captured video data, a first set of one or more in-focus image tiles of the image frame and a second set of one or more out-of-focus image tiles of the image frame.

At block 1230, method 1200 includes applying each of the plurality of image processing operations to the first set of one or more in-focus image tiles.

At block 1240, method 1200 includes applying the first set of one or more critical image processing operations to the second set of one or more out-of-focus image tiles and omitting the second set of one or more non-critical image processing operations for the second set of one or more out-of-focus image tiles.

At block 1250, method 1200 includes generating a complete processed image frame by combining the first set of one or more in-focus image tiles and the second set of one or more out-of-focus image titles.

In some examples, the output complete processed image can be subsequently processed by the same computing device, encoded to another format, stored in local storage of a computing device, and/or sent over a network to another system.

In some examples, the first set of one or more critical image processing operations includes depth estimation. In some examples, the second set of one or more non-critical image processing operations includes temporal noise reduction, high dynamic range (HDR) image enhancement, and/or machine learning processing for object detection.

In some examples, determining the first set of one or more in-focus image tiles of the image frame and the second set of one or more out-of-focus image tiles of the image frame is based on one or more distance measurements.

In some examples, determining the first set of one or more critical image processing operations and the second set of one or more non-critical image processing operations is based on a current operating state of a video capturing device used to capture the captured video data. In some such examples, the current operating state of the video capturing device is associated with a measure of latency of the video capturing device and/or a power or thermal condition of the video capturing device.

Some examples include determining per-tile depth in a processing pipeline, where determining the first set of one or more in-focus image tiles of the image frame and the second set of one or more out-of-focus image tiles of the image frame is based on the determined per-tile depth. Some such examples involve determining per-tile motion vector estimation subsequent to per-tile depth in the processing pipeline, where motion vector estimation is skipped for a particular tile when the particular tile is determined to be out-of-focus based on depth.

In some examples, at least one non-critical processing operation is applied to the one or more in-focus image tiles in parallel with applying a blurring effect to the one or more out-of-focus image tiles.

Some examples include generating and storing a bitmap indicating the one or more out-of-focus image tiles to enable omitting of the one or more non-critical processing operations for the one or more out-of-focus image tiles.

Some examples include mapping the one or more out-of-focus image tiles and the one or more in-focus image tiles to a first data stream identifier corresponding to all image tiles, a second data stream identifier corresponding to out-of-focus image tiles, and third data stream identifier corresponding to in-focus image tiles. In some such examples, the first data stream identifier, the second data stream identifier, and the third data stream identifier are used to apply the one or more critical image processing operations and the one or more non-critical image processing operations. In some such examples, tiles associated with the second data stream identifier and tiles associated with the third data stream identifier are processed in parallel. Some such examples include using a translation lookaside buffer (TLB) for the first data stream identifier, the second data stream identifier, and the third data stream identifier.

Some examples include adjusting a number of tiles to divide the image frame into based on contents of the image frame.

In some examples, method 1200 is carried out by a video capturing device comprising one or more processors and one or more non-transitory computer readable media storing program instructions executable by the one or more processors.

In some examples, method 1200 is carried out using one or more non-transitory computer readable media storing program instructions executable by one or more processors, which may be located on and/or remote from a video capturing device.

### III. CONCLUSION

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for the purpose of illustration and are not intended to be limiting, with the true scope being indicated by the following claims.

1. A method comprising:
determining, from a plurality of image processing operations and for generation of captured video data with out-of-focus blurring, a first set of one or more critical image processing operations and a second set of one or more non-critical image processing operations;
determining, for an image frame of the captured video data, a first set of one or more in-focus image tiles of the image frame and a second set of one or more out-of-focus image tiles of the image frame;
applying each of the plurality of image processing operations to the first set of one or more in-focus image tiles;
applying the first set of one or more critical image processing operations to the second set of one or more out-of-focus image tiles and omitting the second set of one or more non-critical image processing operations for the second set of one or more out-of-focus image tiles; and
generating a complete processed image frame by combining the first set of one or more in-focus image tiles and the second set of one or more out-of-focus image tiles.

2. The method of claim 1, wherein the first set of one or more critical image processing operations includes depth estimation.

3. The method of claim 1, wherein the second set of one or more non-critical image processing operations includes temporal noise reduction.

4. The method of claim 1, wherein the second set of one or more non-critical image processing operations includes high dynamic range (HDR) image enhancement.

5. The method of claim 1, wherein the second set of one or more non-critical image processing operations includes machine learning processing for object detection.

6. The method of claim 1, wherein determining the first set of one or more in-focus image tiles of the image frame and the second set of one or more out-of-focus image tiles of the image frame is based on one or more distance measurements.

7. The method of claim 1, wherein determining the first set of one or more critical image processing operations and the second set of one or more non-critical image processing operations is based on a current operating state of a video capturing device used to capture the captured video data.

8. The method of claim 7, wherein the current operating state of the video capturing device is associated with a measure of latency of the video capturing device.

9. The method of claim 7, wherein the current operating state of the video capturing device is associated with a power or thermal condition of the video capturing device.

10. The method of claim 1, further comprising determining per-tile depth in a processing pipeline, wherein determining the first set of one or more in-focus image tiles of the image frame and the second set of one or more out-of-focus image tiles of the image frame is based on the determined per-tile depth.

11. The method of claim 10, further comprising determining per-tile motion vector estimation subsequent to per-tile depth in the processing pipeline, wherein motion vector estimation is skipped for a particular tile when the particular tile is determined to be out-of-focus based on depth.

12. The method of claim 1, wherein at least one non-critical processing operation is applied to the one or more in-focus image tiles in parallel with applying a blurring effect to the one or more out-of-focus image tiles.

13. The method of claim 1, further comprising generating and storing a bitmap indicating the one or more out-of-focus image tiles to enable omitting of the one or more non-critical processing operations for the one or more out-of-focus image tiles.

14. The method of claim 1, further comprising mapping the one or more out-of-focus image tiles and the one or more in-focus image tiles to a first data stream identifier corresponding to all image tiles, a second data stream identifier corresponding to out-of-focus image tiles, and third data stream identifier corresponding to in-focus image tiles.

15. The method of claim 14, wherein the first data stream identifier, the second data stream identifier, and the third data stream identifier are used to apply the one or more critical image processing operations and the one or more non-critical image processing operations.

16. The method of claim 14, wherein tiles associated with the second data stream identifier and tiles associated with the third data stream identifier are processed in parallel.

17. The method of claim 14, further comprising using a translation lookaside buffer (TLB) for the first data stream identifier, the second data stream identifier, and the third data stream identifier.

18. The method of claim 1, further comprising adjusting a number of tiles to divide the image frame into based on contents of the image frame.

19. A video capturing device comprising one or more processors and one or more non-transitory computer readable media storing program instructions executable by the one or more processors to perform operations comprising:
determining, from a plurality of image processing operations and for generation of captured video data with out-of-focus blurring, a first set of one or more critical image processing operations and a second set of one or more non-critical image processing operations;
determining, for an image frame of the captured video data, a first set of one or more in-focus image tiles of the image frame and a second set of one or more out-of-focus image tiles of the image frame;
applying each of the plurality of image processing operations to the first set of one or more in-focus image tiles;
applying the first set of one or more critical image processing operations to the second set of one or more out-of-focus image tiles and omitting the second set of one or more non-critical image processing operations for the second set of one or more out-of-focus image tiles; and
generating a complete processed image frame by combining the first set of one or more in-focus image tiles and the second set of one or more out-of-focus image tiles.

20. One or more non-transitory computer readable media storing program instructions executable by one or more processors to perform operations comprising:
determining, from a plurality of image processing operations and for generation of captured video data with out-of-focus blurring, a first set of one or more critical image processing operations and a second set of one or more non-critical image processing operations;
determining, for an image frame of the captured video data, a first set of one or more in-focus image tiles of the image frame and a second set of one or more out-of-focus image tiles of the image frame;
applying each of the plurality of image processing operations to the first set of one or more in-focus image tiles;
applying the first set of one or more critical image processing operations to the second set of one or more out-of-focus image tiles and omitting the second set of one or more non-critical image processing operations for the second set of one or more out-of-focus image tiles; and
generating a complete processed image frame by combining the one or more in-focus image tiles and the one or more out-of-focus image tiles.
